(19) United States
(12) Patent Application Publication
(10) Pub. No.: US 2005/0023973 A1
(43) Pub. Date: Feb. 3, 2005

(54) Light emitting unit for displaying light of different colors from two sides

(76) Inventors: Yan-Ming Huang, Taichung County (TW); Jun-Chin Chang, Taichung County (TW); Yi-Hsuan Liu, Hsinchu County (TW)

Correspondence Address: BIRCH STEWART KOLASCH & BIRCH, PO BOX 747, FALLS CHURCH, VA, 22040-0747, US

(21) Appl. No.: 10/629,782

(22) Filed: Jul. 30, 2003

(51) Int. Cl. H01J 5/16; H01K 1/26

(52) U.S. Cl. 313/512; 313/112; 313/506

(57) ABSTRACT

A light emitting unit for displaying light of different colors from two sides employs thin film filters of inorganic optical films. The inorganic optical film filters have the property of not absorbing moisture, thus do not damage light emitting elements. Moreover, the inorganic optical films do not absorb light, hence can fully filter the required light for use. The invention provides a technique that plates respectively a required inorganic optical film on the electrode or transparent substrate and a transparent package cap on two sides of an element. When light is generated from a light emitting element and passes through the color filters made of the inorganic optical films at two ends of the element, the inorganic optical films filter the light to become colored lights for displaying.

### FIELD OF THE INVENTION

The present invention relates to a light emitting unit that is capable of displaying light of different colors from two sides to enable a flat panel display to display light of different colors from two sides.

### BACKGROUND OF THE INVENTION

Flat panel display (FPD) is in great demand these days. In the present market around the world, slim and light and power saving is a prevailing trend. CRT has been gradually replaced by the FPD. The main technologies adopted on the FPD can be grouped in Plasma Display, Liquid Crystal Display, Electroluminescent Display, Light Emitting Diode, Vacuum Fluorescent Display, Field Emission Display, and Electrochromic Display.

Organic Light Emitting Diodes (OLED) display, based on the light emitting material being used, can be classified in two types: small molecule type and polymer type. As the OLED has many features such as no restriction on viewing angle, lower fabrication cost, faster response time (more than one hundred times faster than liquid crystals), saving electric power, able to be driven by DC for use on portable devices, wide applicable temperature range, lighter weight and adaptable to miniaturized and thinner hardware equipment, it meets display requirements in the multimedia era. Hence the organic electroluminescent element has a great potential among the flat panel display systems. It could become a popular flat panel display of the next generation. However, full color enabling has always been a critical technology in the organic electroluminescent display.

At present there are many methods to achieve full color enabling for the flat panel display: the first method is RGB array type which is fabricating RGB elements on the substrate to enable individual pixel to display RGB color respectively; the second method uses a white light emitting element to couple with color filters in which the white light passes through the color filters to generate RGB color lights; the third method is coupling blue light with a light transformation layer that employs the blue light to agitate the light transformation layer to generate green light and red light to form RGB color lights (RGB=the original three colors of red, green and blue). All the three methods set forth above have their advantages and drawbacks. In the following, only the drawbacks of the second method are discussed.

The conventional manufacturing process for the second method that uses a white light to couple with color filters employs photolithography and etching processes to transfer-print a patterned photoresist on an inner side of a glass substrate. When light passes through the filters, the lights of the filters are displayed. But this method is not suitable for the self lighting flat panel display such as small molecule OLED, polymer electroluminescent element (PLED), or the like. It is because the photoresist tends to absorb moisture and could result in degradation of the light emitting elements. Moreover, the photoresist will absorb a portion of light and result in dropping of light utilization efficiency.

### SUMMARY OF THE INVENTION

The primary object of the invention is to resolve the aforesaid disadvantages and eliminate the shortcomings of the prior art. The invention provides a technique to fabricate full color display elements. The invention employs a thin film filter made of an inorganic film. The filter of the inorganic film does not absorb moisture, thus does not cause damage to the light emitting elements. In addition, as the inorganic filter does not absorb moisture, it can filter all the required lights to increase light utilization efficiency of the elements. Coupled with the filters of the three original colors (red, green and blue) designed based on the inorganic films, the problem of impure light occurred previously may be overcome. And pure three original lights may be generated after the light passing through the filters. The technique provided by the invention includes plating depositing respectively a required inorganic optical film on the electrode or transparent substrate and a package cap on two sides of an element. When light is generated from the light emitting element and passes through the color filters made of the inorganic optical films at two ends of the element, the inorganic optical films filter the light to display colored lights.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a first embodiment of the light emitting unit of the invention.

FIG. 2 is a schematic view of a second embodiment of the light emitting unit of the invention.

FIG. 3 is a schematic view of a third embodiment of the light emitting unit of the invention.

FIG. 4 is a schematic view of a fourth embodiment of the light emitting unit of the invention.

FIG. 5 is a schematic view of a fifth embodiment of the light emitting unit of the invention.

FIG. 6 is a schematic view of a sixth embodiment of the light emitting unit of the invention.

### DETAILED DESCRIPTION OF THE PREFERRED EMBODIMENTS

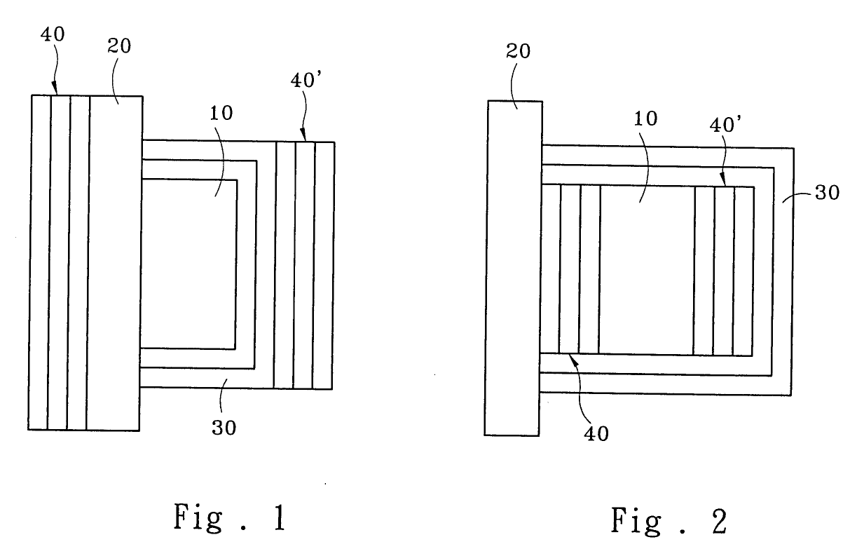

Please refer to FIG. 1 for a schematic view of a first embodiment of the light emitting unit of the invention. The invention employs a structure of inorganic optical films 40 and 40′ to couple with a transparent light emitting element 10 which is able to generate light to accomplish the object of displaying different colors of light from two sides. The fabrication method is as follows: plating depositing an inorganic optical film 40 on an outer side of a transparent substrate 20 and plating depositing another inorganic optical film 40′ on an inner side or an outer side of a transparent package cap so that they are equipped with the properties of high pass filter, lower pass filter or band pass filter. Then the inorganic optical films 40 and 40′ may be used to filter light to generate the required colored lights.

Refer to FIG. 2 for a schematic view of a second embodiment of the light emitting unit of the invention. To fabricate the light emitting element 10, first plate an inorganic optical film 40 on an inner side of a transparent substrate 20, next fabricate the completed light emitting element 10 thereon (such as plating evaporating by vaporizing OLED organic layers and metal layers, or spin coating organic layers and plating evaporating metal layers by vaporizing of PLED); then plate an inorganic optical film 40′ that has the required properties; finally package a transparent cap 30 to complete the production.

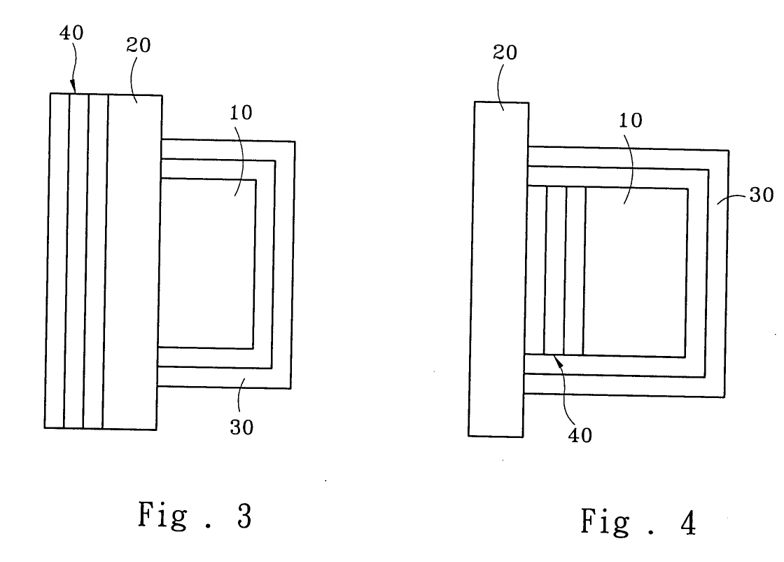

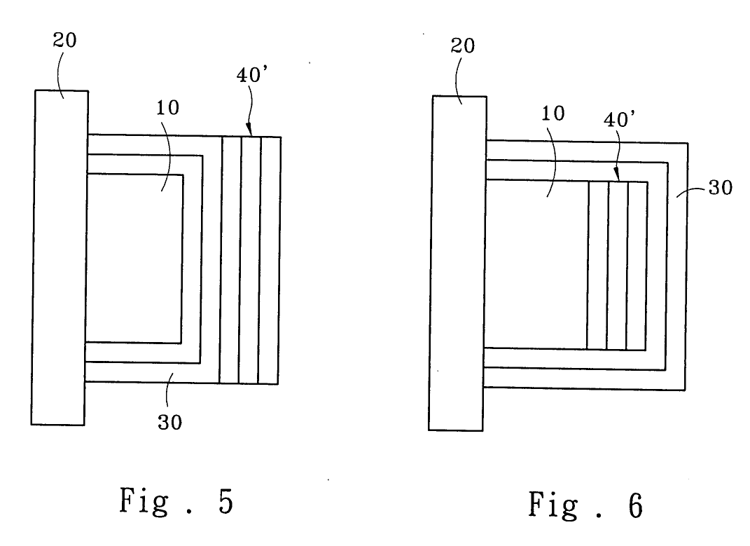

FIGS. 3, 4, 5 and 6 illustrate the structures of the third, fourth, fifth and sixth embodiment of the light emitting element 10 of the invention. As shown in the drawings, the inner side or outer side of the transparent substrate or transparent package cap on two sides of the light emitting element 10 may be plated with required inorganic optical films 40 and 40′. The inorganic optical films 40 and 40′ have the properties of a color filter. When light generated by the light emitting element 10 passes through the inorganic optical films 40 and 40′ at two ends of the element, the color filters composed of the inorganic optical films 40 and 40′ will display the color filtered by the filters. For instance, if the light source of the light emitting element 10 contains red and green lights, and the lights pass through green inorganic optical films 40 and 40′, only the green light will be displayed. If there is a red inorganic optical films 40 and 40′ located on other side, only the red light will be displayed. Thus the two ends of the element will display red light and green light to accomplish the object of displaying two different colors of lights from two sides.

As previously discussed, if the light source of the light emitting element 10 is white (composed of red and blue lights), the matching inorganic optical films 40 and 40′ may be orange and blue, or one side plated with an optical filter to enable one side of the element to display the filtered light while other side remains the original color light (i.e. orange and white, or blue and white) for outputting. The optical films may be made from inorganic materials and refractive indexes as follows: Si n=3.4, CdS n=2.35, TiO₂ n=2.4, ITO (Indium Tin Oxide) n=1.9, SiO₂ n=1.45, ZnO n=2.1, ZnO₂ n=2.3, Al₂O₃ n=1.62, BaF₂ n=1.47, SnO₂ n=2.0, ZrO₂ n=2.05, CeO₂ n=2.22, MgF₂ n=1.38. etc.

For instance, with the light emitting element 10 that generates white light (made by applicant) and is composed of blue light (464 nm) and orange light (572 nm), the wave valley is located on 524 nm, orange light above 524 nm may be filtered and displayed. The inorganic optical films 40 and 40′ may be made from materials and refractive indexes as follows: TiO₂ (n=2.55), MgF₂ (n=1.38), SiO₂ (n=1.45), CdS (n=2.35). The layer structure and thickness are as follows: TiO₂ 16.04 nm/MgF₂ 250.24 nm/TiO₂ 107.02 nm/MgF₂ 227.5 nm/TiO₂ 55.58 nm/SiO₂ 76.40 nm/CdS 32.88 nm/SiO₂ 79.41 nm/CdS 54.38 nm/SiO₂ 84.82 nm/CdS 45.23 nm/SiO₂ 67 nm/CdS 48.85 nm/SiO₂ 85.05 nm/CdS 50.52 nm/SiO₂ 69.6 nm/CdS 42.54 nm/SiO₂ 75.86 nm/CdS 43.58 nm/SiO₂ 141.7 nm.

The thickness and materials of the inorganic optical films 40 and 40′ may also be altered to achieve the same result. The selected materials and refractive indexes are as follows: TiO₂ (n=2.55), MgF₂ (n=1.38), SiO₂ (n=1.45), CdS (n=2.35). The layer structure and thickness are as follows: TiO₂ 10.5 nm/MgF₂ 296.59 nm/TiO₂ 41.6 nm/SiO₂ 63.28 nm/CdS 14.72 nm/CdS 30.72 nm/SiO₂ 79.42 nm/CdS 49.78 nm/SiO₂ 76.98 nm/CdS 46.18 nm/SiO₂ 74.51 nm/CdS 48.62 nm/SiO₂ 79.9 nm/CdS 49.44 nm/SiO₂ 73.44 nm/CdS 42.67 nm/SiO₂ 74.58 nm/CdS 52.1 nm/SiO₂ 32.57 nm/SiO₂ 61.4 nm/CdS 10.29 nm.

Moreover, the material and thickness of various layers may also be changed to achieve the same result. The layer structure and thickness are as follows: CdS 24.1 nm/SiO₂ 62.89 nm/CdS 16.54 nm/CdS 32.11 nm/SiO₂ 79.9 nm/CdS 45.01 nm/SiO₂ 73.96 nm/CdS 47.95 nm/SiO₂ 78.31 nm/CdS 47.57 nm/SiO₂ 76.12 nm/CdS 48.14 nm/SiO₂ 78.88 nm/CdS 43.44 nm/SiO₂ 69.6 nm/CdS 54.5 nm/SiO₂ 17.19 nm/SiO₂ 46.03 nm/CdS 56.02 nm.

In addition, in order to filter out blue light below 524 nm, the materials and refractive index of the inorganic optical films 40 and 40′ may be selected as follows: SiO₂ (n=1.45), CdS (n=2.35). The layer structure and thickness are as follows: SiO₂ 43.55 nm/CdS 82.38 nm/SiO₂ 119.94 nm/CdS 78.47 nm/SiO₂ 129.5 nm/CdS 78.38 nm/SiO₂ 121.62 nm/CdS 64.18 nm/SiO₂ 127.71 nm/CdS 49.36 nm/SiO₂ 125.35 nm/CdS 69.14 nm/SiO₂ 134.74 nm/CdS 87.78 nm/SiO₂ 133.41 nm/CdS 66.81 nm/SiO₂ 114.91 nm/CdS 69.09 nm/SiO₂ 138.15 nm/CdS 97.03 nm/SiO₂ 134.6 nm/CdS 67.22 nm/SiO₂ 103.7 nm/CdS 68.24 nm/SiO₂ 102.24 nm/CdS 63.79 nm/SiO₂ 109.02 nm/CdS 62.74 nm/SiO₂ 102.8 nm/CdS 68.61 nm/SiO₂ 108.19 nm/CdS 69.48 nm/SiO₂ 133.73 nm/CdS 109.22 nm/SiO₂ 161.39 nm/CdS 91.66 nm/SiO₂ 60.93 nm.

The materials and thickness of the inorganic optical films 40 and 40′ may also be altered. The selected materials and refractive indexes are as follows: TiO₂ (n=2.55), MgF₂ (n=1.38), SiO₂ (n=1.45), CdS (n=2.35). The layer structure and thickness are as follows: TiO₂ 3.63 nm/MgF₂ 16.2 nm/CdS 78.93 nm/SiO₂ 114.9 nm/CdS 83.76 nm/SiO₂ 166.79 nm/CdS 87.35 nm/SiO₂ 110.08 nm/CdS 66.09 nm/SiO₂ 121.73 nm/CdS 49.36 nm/SiO₂ 127.91 nm/CdS 73.91 nm/SiO₂ 174.07 nm/CdS 92.48 nm/SiO₂ 91.87 nm/CdS 73.64 nm/SiO₂ 111.61 nm/CdS 60.25/SiO₂ 143.67 nm/CdS 109.84 nm/SiO₂ 126.67 nm/CdS 69.39 nm/SiO₂ 101.19 nm/CdS 65.85 nm/SiO₂ 107.78 nm/CdS 61.90 nm/SiO₂ 104.63 nm/CdS 67.67 nm/SiO₂ 98.81 nm/CdS 64.47 nm/SiO₂ 117.77 nm/CdS 54.65 nm/SiO₂ 127.25 nm/CdS 161.24 nm/SiO₂ 144.95 nm/CdS 119.83/SiO₂ 76.1 nm.

Furthermore, the materials and thickness of the inorganic optical films 40 and 40′ may also be altered to achieve the same result. To filter out blue light below 524 nm, the selected materials and refractive indexes for the inorganic optical films 40 and 40′ are as follows: BaF₂ (n=1.46), TiO₂ (n=2.55), MgF₂ (n=1.38), SiO₂ (n=1.45), CdS (n=2.35). The layer structure and thickness are as follows: BaF₂ 148.25 nm/TiO₂ 81.47 nm/BaF₂ 127.2 nm/TiO₂ 5.22 nm/MgF₂ 151.39 nm/CdS 72.68 nm/SiO₂ 99.55 nm/CdS 83.8 nm/SiO₂ 205.62 nm/CdS 85.9 nm/SiO₂ 94.3 nm/CdS 65.02 nm/SiO₂ 123.82 nm/CdS 85.9 nm/SiO₂ 94.3 nm/CdS 65.02 nm/SiO₂ 123.82 nm/CdS 49.36 nm/SiO₂ 118.44 nm CdS 78.58 nm/SiO₂ 194.43 nm/CdS 88.4/SiO₂ 88.8 nm/CdS 70.8 nm/SiO₂ 117.51 nm/CdS 52.51 nm/SiO₂ 140.38 nm/CdS 124.11 nm/SiO₂ 132.54 nm/CdS 61.32 nm/SiO₂ 109.15 nm/CdS 66.18 nm/SiO₂ 100.29 nm/CdS 64.98/SiO₂ 107.44 nm/CdS 62.78 nm/SiO₂ 104.68 nm/CdS 66.6 nm/SiO₂ 103.38 nm/CdS 66.42 nm/SiO₂ 117.92 nm/CdS 167.13 nm/SiO₂ 142.56/CdS 105.52 nm/SiO₂ 78.47 nm.

1. A light emitting unit for displaying different colors of light from two sides, comprising:
a light emitting element;
a transparent substrate located on a display side of the light emitting element;
a transparent package cap for packaging the light emitting element;
a first inorganic optical film located on the transparent substrate; and
a second inorganic optical film located on the package cap;
wherein the light emitting element generates light which passes through and is filtered by the inorganic optical films to display required colored lights on two sides of the light emitting element.

2. The light emitting unit for displaying different colors of light from two sides of claim 1, wherein the inorganic optical films are made from combination of materials selected from Si, CdS, TiO₂, Ta₂O₃, Indium Tin Oxide, SiO₂, ZnO, ZnO₂, Al₂O₃, BaF₂, SnO₂, ZrO₂, CeO₂, and MgF₂.

3. The light emitting unit for displaying different colors of light from two sides of claim 1, wherein the inorganic optical films are made by sputter plating deposition of physical vapor deposition (PVD).

4. The light emitting unit for displaying different colors of light from two sides of claim 1, wherein the inorganic optical films are made by electron beam evaporation (EBE) of physical vapor deposition (PVD).

5. The light emitting unit for displaying different colors of light from two sides of claim 1, wherein the first inorganic optical film is located on an outer side of the transparent substrate.

6. The light emitting unit for displaying different colors of light from two sides of claim 1, wherein the first inorganic optical film is located on an inner side of the transparent substrate.

7. The light emitting unit for displaying different colors of light from two sides of claim 1, wherein the second inorganic optical film is located on an outer side of the transparent package cap.

8. The light emitting unit for displaying different colors of light from two sides of claim 1, wherein the second inorganic optical film is located on an inner side of the transparent package cap.

9. The light emitting unit for displaying different colors of light from two sides of claim 1, wherein the thickness of the inorganic optical films are alterable according the colored light to be passed through.

10. The light emitting unit for displaying different colors of light from two sides of claim 1, wherein the layer number of the inorganic optical films are alterable according the colored light to be passed through.
